(19) United States
(12) Patent Application Publication
(10) Pub. No.: US 2007/0011249 A1
(43) Pub. Date: Jan. 11, 2007

(54) Multi-function printing device

(76) Inventors: Amanda K. Bridges, Winchester, KY (US); William J.G. Flowers, Lexington, KY (US); Charles E. Grieshaber, Versailles, KY (US); Chad E. McQuillen, Lexington, KY (US); Michael R. Timperman, Versailles, KY (US)

Correspondence Address: LEXMARK INTERNATIONAL, INC.;INTELLECTUAL PROPERTY LAW DEPARTMENT, 740 WEST NEW CIRCLE ROAD, BLDG. 082-1, LEXINGTON, KY, 40550-0999, US

(21) Appl. No.: 11/178,574

(22) Filed: Jul. 11, 2005

(51) Int. Cl. G06F 15/16

(52) U.S. Cl. 709/206

(57) ABSTRACT

A method of producing an electronic document from a multi-function printing device. The method includes the acts of creating an electronic document, configuring the device with a list of destinations including at least one domain name, formatting the electronic document to be delivered via an electronic mail message, addressing the electronic mail message with an address including a domain and determining if the domain name in the address matches the domain name included in the list of destinations.

### BACKGROUND

The present invention relates to multi-function printing devices and, more particularly, to multi-function printing devices capable of creating electronic documents and sending electronic mail messages.

### SUMMARY

In one embodiment, the invention provides a method of producing and delivering an electronic document from a multi-function printing device. The method includes creating an electronic document, configuring the device with a list of destinations including at least one domain name, formatting the electronic document to be delivered via an electronic mail message, addressing the electronic mail message with an address including a domain name and determining if the domain name in the address matches the domain name included in the list of destinations.

In another embodiment, the invention provides a method of delivering an electronic document from a multi-function printer. According to the method, the electronic document is created by the multi-function printer. The method includes configuring the multi-function printer with a list of allowed destinations, formatting the electronic document to be delivered via an electronic mail message, addressing an address field of the electronic mail message with a first destination and determining if the first destination is included in the list of allowed destinations. The method also includes removing the first destination from the address field of the electronic mail message if the first destination is not included in the list of destinations.

In a further embodiment, the invention provides a multi-function device operable to produce an electronic document. The device includes a controller configured to communicate to a server via a network and operable to send an electronic mail message. The controller also has a user-configurable setting, which includes a list of allowed destinations to which the controller can send electronic mail messages. The electronic mail message has an address field and includes the electronic document. Also, the controller is operable to parse the address field of the electronic mail message for a destination, compare the destination included in the address field to the list of allowed destinations and determine whether or not the destination is included in the list of allowed destinations.

Other aspects of the invention will become apparent by consideration of the detailed description and accompanying drawings.

### BRIEF DESCRIPTION OF THE DRAWINGS

FIG. 1 is a schematic illustration of a multi-function printing device embodying the invention.

FIG. 2 is a flowchart of operation of the multi-function printing device of FIG. 1.

FIG. 3 is a schematic illustration of a configuration page of the multi-function of FIG. 1.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

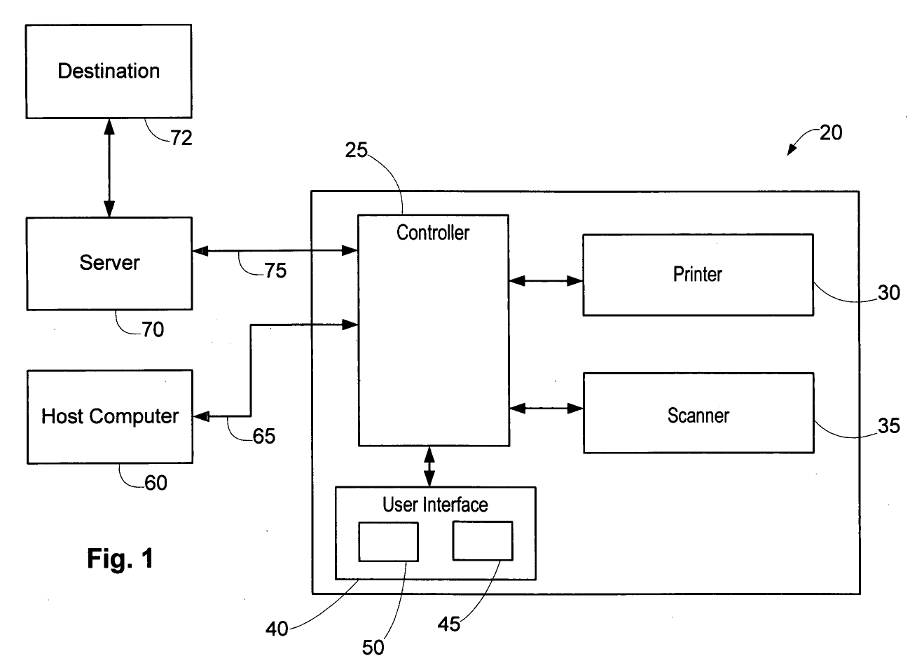

FIG. 1 schematically shows a device 20 capable of performing one or several related tasks in the area of scanning, printing, duplicating and/or faxing documents. In some embodiments, the device 20 can be a multi-function printer (“MFP”) that can perform several processing functions, such as, for example, printing, scanning, electronic mailing, faxing, duplicating and other various functions. In other embodiments of the invention, the device 20 can be limited to a single document processing function, such as, for example, printing, scanning, duplicating or other related functions. For example, the device 20 can be a printer, a scanner, a copy machine or the like. In the construction shown in FIG. 1, the device 20 is an MFP.

As shown in FIG. 1, the MFP 20 includes a controller 25. In the illustrated construction, the controller 25 monitors operation of the MFP 20 and controls the various functions of MFP 20, such as printing, scanning, duplicating and the like. The controller 25 also communicates with various document processing modules included in the MFP 20, such as, for example, a printer 30 and a scanner 35. The controller 25 may also communicate with various devices external to the MFP 20, as discussed below.

As mentioned previously, in some constructions, the MFP 20 includes various document processing modules, such as the printer 30 and the scanner 35. The printer 30 is operable to receive an electronic document representing a desired image from the controller 25. The printer 30 is also operable to print a hard copy of that desired image on a print medium, such as a sheet of paper (not shown). For example, the printer 30 communicates with the controller 25 and can receive an electronic document in a printer format from the controller 25 and instructions that cause the printer to print in a desired manner, as is known in the art.

The scanner 35 includes a scanning area (not shown) on which an original document can be placed either manually or automatically by being sequentially fed from a feeder tray or automatic document feeder unit (not shown) under the control of the controller 25. For example, if the original includes multiple pages, an automatic feeder function (not shown) of the device 20 sequentially feeds the pages to the scanning area from the feeder tray. Different types of scanners which include various different sensors for producing an electronic document of scanned image data are known in the art. An illumination system (not shown) provides proper light such that the sensors can obtain accurate readings of the original document. The scanned image data represents the original document. The controller 25 is also operable to convert scanned image data from the scanner 35 into an electronic document in a printer format.

In the construction shown, the MFP 20 can also include a user interface 40. The user interface 40 can allow a user to control and monitor the various document processing functions. The user interface 40 includes at least one user control 45 to prompt the device 20 to perform a function or to modify a particular function. In some constructions, the user control 45 includes one or more push buttons. In other constructions, the user control 45 includes a keypad or a mouse.

In the construction illustrated in FIG. 1, the user interface 40 can also include a display 50. The display 50 can relay information to the user through various menus and screens, as discussed below. In some constructions, such as the construction illustrated in FIG. 1, the display 50 is separate from the user control 45. In other constructions, the display 50 can be combined with the user control 45, such as a touch-screen display.

In the illustrated construction, the controller 25 is operable to communicate with one or more devices. For example, as shown in FIG. 1, the controller 25 can communicate with a host computer 60. The host computer 60 can send information (such as, for example, an electronic document in a printer format), commands, code and the like to the controller 25 of the MFP 20, and in turn, the controller 25 can also send information to the host computer 60. Communication can take place between the controller 25 and the host computer 60 via a first link 65. In some constructions, the link 65 can include a network, such as a wireless network, a wired network or a combination of both. In other constructions, the link 65 can be a phone line, a serial cable, a parallel cable or another similar wired or wireless link.

Still referring to FIG. 1, the controller 25 is also operable to communicate with additional devices, such as, a server 70. In some constructions, the MFP 20 can be configured to format and send electronic mail (“e-mail”) messages through the server 70. For example, the MFP 20 can create an electronic document, such as an electronic document produced by the scanner 35, and can include the electronic document in an e-mail to be sent to one or more destinations 72. As shown in FIG. 1, the e-mail message can be sent to one or more destinations 72 via the server 70. Destinations 72 can include specific e-mail addresses, distribution groups, specific IP addresses, etc. In one construction, the server 70 can include an SMTP server. In yet other constructions, the controller 25 may communicate directly with additional devices and send electronic mail messages without the use of a server.

Communication can take place between the controller 25 and the server 70 via a second link 75. In some constructions, the second link 75 can also be the same network which links the MFP 20 with the host computer 60. In other constructions, the second link 75 can be separate from the first link 65, such as, for example, a second wireless network, a second wired network, a second combination of both, a second phone line, a second serial cable, a second parallel cable or another similar wired or wireless link.

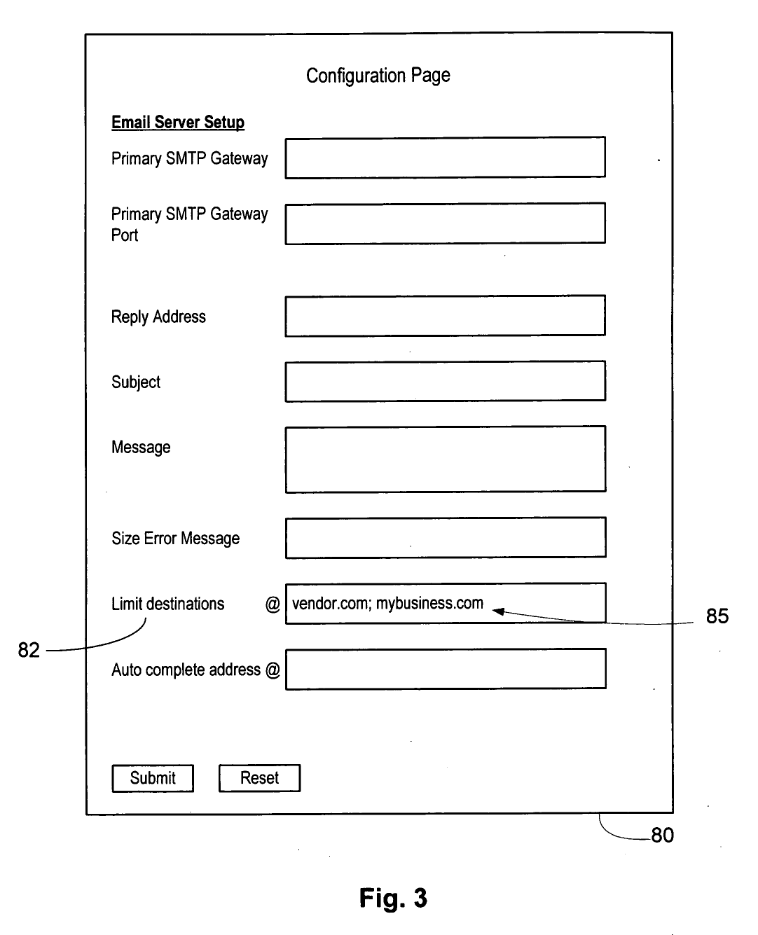

In some constructions, the controller 25 is also operable to include various settings that can be configured by a user. As shown in FIG. 3, the controller 25 includes one or more settings which can be accessed by a user through one or more configuration pages 80 of the device 20. In one construction, the configuration pages 80 can be accessed by a user through the user interface 40. In another construction, the configuration pages 80 can be accessed by a user through the host computer 60. In further constructions, the configuration pages 80 can be accessed by a user remotely through a device (not shown) connected to the MFP 20 via a network, such as the Internet. In some constructions, the configuration pages 80 can only be accessed by certain users that have clearance to modify the settings, such as, for example, systems administrators.

In the illustrated construction, the configuration pages 80 include a setting 82 that restricts the destinations of e-mail messages. The setting 82 includes a list 85 of destinations to which the MFP 20 can send e-mail messages. For example, if a user inputs a destination into the address field of an e-mail message and that destination is not included in the list 85 of allowed destinations, the controller 25 will remove that destination from the address field of the message prior to sending the e-mail message to the server 70. In some constructions, the list 85 of destinations can be created and modified by a user through the configuration pages 80.

In one example, the list 85 of destinations includes a list of domain names which are included in email addresses, such as mybusiness.com or vendor.com. In this example, the controller 25 is configured to send e-mail messages to any e-mail address including the domain name “mybusiness.com” or “vendor.com”. In this example, if a user inputs the destination of “johndoe@buyer.com” in the address field of the message, the controller 25 will remove that destination from the address field because “buyer.com” is not a domain name included in the list 85 of allowed destinations. In other constructions, the controller 25 may delete the electronic message if the destination is not an allowed destination.

In another example, the list 85 of destinations includes a list of specific e-mail addresses, such as johndoe@mybusiness.com and janedoe@vendor.com. In this example, the controller 25 is configured to send e-mail messages to only those e-mail addresses that match the addresses included in the list 85.

The controller 25 can also be configured, via the configuration pages 80, to generate an error report. In some constructions, the error report is generated when the controller 25 removes destinations from the address field of an e-mail message. The error report can include the destinations entered by the user that were removed from the address field of the message. The error report can also include the reasons why the e-mail message was not delivered to those destinations. In some constructions, the error report is automatically sent to the host computer 60, the user's workstation (not shown) or the user's e-mail address. In other constructions, the error report is displayed on the display 50 of the user interface 40.

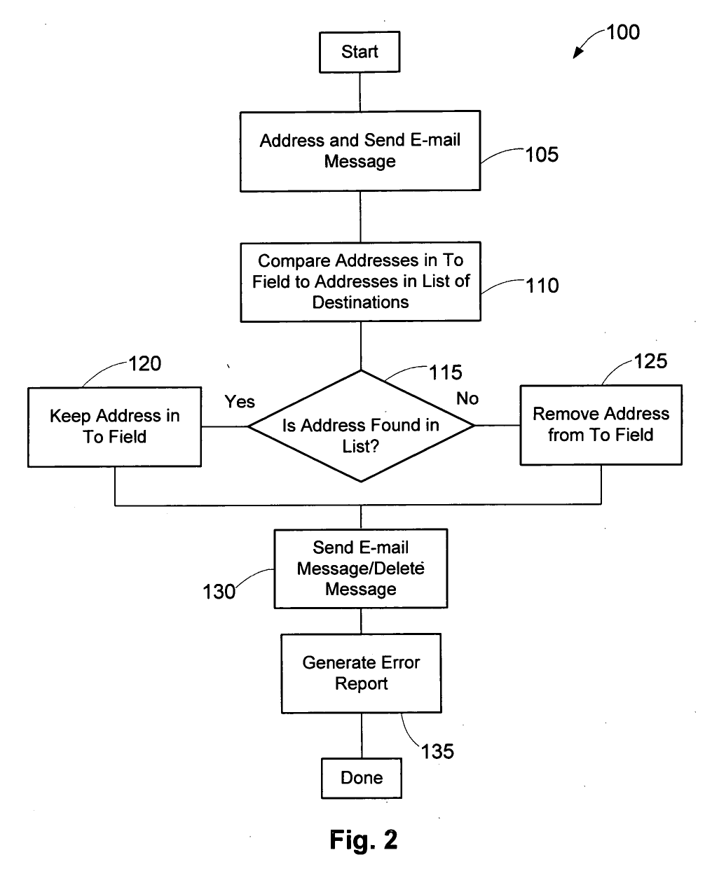

FIG. 2 is a flowchart detailing operation 100 of the MFP 20 using the limit destination setting. The process begins by the controller 25 formatting an e-mail message to be sent to one or more destinations, such as one or more e-mail addresses, at step 105. In some constructions, a user prompts the MFP 20 to create an e-mail message and then the user inputs destinations into the address field (e.g., the To field) of the e-mail message. At step 110, the controller 25 parses the address field of the e-mail message for each destination and compares each destination to the list 85 of allowed destinations.

At step 115, the controller 25 determines if the destinations included in the address field of the message are also included in the list 85 of destinations. If the destination being compared to the list 85 is included in the list 85 at step 115, such as, for example, if the destination is an e-mail address containing a domain name found in the list 85 of allowed domain name destinations, then the controller 25 keeps the allowed destination in the address field of the message at step 120.

If a destination is not included in the list 85 at step 115, such as, for example, if the destination is an e-mail address which does not contain a domain name found in the list 85 of allowed domain name destinations, then the controller 25 removes that particular destination from the address field at step 125. Once the controller 25 compares all the destinations to the list 85 at step 110, determines whether or not each destination is an allowed destination at step 15 and either keeps or removes each destination from the address field at steps 120 and 125, the controller 25 sends the e-mail message including the allowed destinations (if applicable) to the server 70 for delivery to the destinations 72 at step 130. If the address field of the message does not include any destinations (e.g., all destinations were removed from the To field), the controller 25 deletes the message at step 130. Then, if applicable, the controller 25 generates an error report at step 135. The error report indicates that the message was not sent to those destinations and explains why those destinations were removed from the address field.

Thus, the invention provides, among other things, a multi-function printing device having a limit destination setting. Various features and advantages of the invention are set forth in the following claims.

What is claimed is:

1. A method of producing an electronic document from a multi-function printing device, the method comprising:
creating an electronic document;
configuring the multi-function printing device with a list of destinations including a first domain name;
formatting the electronic document to be delivered via an electronic mail message;
addressing the electronic mail message with an address including a second domain name; and
determining if the second domain name in the address matches the first domain name included in the list of destinations.

2. The method of claim 1, further comprising delivering the electronic mail message to the address if the second domain name in the address matches the first domain name included in the list of destinations.

3. The method of claim 1, further comprising deleting the electronic mail message if the second domain name does not match the first domain name included in the list of destinations.

4. The method of claim 1, further comprising generating an error report if the second domain name does not match the first domain name included in the list of destinations.

5. The method of claim 4, wherein the error report indicates that the electronic mail message was not delivered to the address.

6. The method of claim 5, wherein the error report further indicates why the electronic mail message was not delivered to the address.

7. The method of claim 1, further comprising:
addressing the electronic mail message with a second address including a third domain name; and
determining if the third domain name in the address matches the first domain name included in the list of destinations.

8. The method of claim 7, further comprising delivering the electronic mail message to the second address if the third domain name in the second address matches the first domain name included in the list of destinations.

9. The method of claim 7, further comprising deleting the electronic mail message to the second address if the third domain name of the second address does not match the first domain name included in the list of destinations.

10. The method of claim 1, wherein creating an electronic document includes creating an electronic document of scanned image data by a scanner.

11. A method of delivering from a multi-function printer an electronic document created by the multi-function printer, comprising:
configuring, the multi-function printer with a list of allowed destinations;
formatting the electronic document to be delivered via an electronic mail message;
addressing a To field of the electronic mail message with a first destination;
determining if the first destination is included in the list of allowed destinations; and
if the first destination is not included in the list of destinations, removing the first destination from the To field of the electronic mail message.

12. The method of claim 11, further comprising delivering the electronic mail message to the destination included in the To field.

13. The method of claim 11, further comprising generating an error report.

14. The method of claim 13, wherein the error report indicates that the electronic mail message was not delivered to the destination.

15. A multi-function device operable to produce an electronic document, comprising: a controller configured to communicate to a server via a network and operable to send an electronic mail message, the electronic mail message having an address field and including the electronic document, the controller having an user-configurable setting, the setting including a list of allowed destinations which the controller can send electronic mail messages; and wherein the controller is operable to parse the address field of the electronic mail message for a destination, compare the destination included in the address field to the list of allowed destinations and determine whether or not the destination is included in the list of allowed destinations.

16. The multi-function device of claim 15, wherein the controller is further operable to keep the destination in the address field if the destination is included in the list of allowed destinations.

17. The multi-function device of claim 15, wherein the controller is further operable to send the electronic mail message to the destination in the address field if the destination is included in the list of allowed destinations.

18. The multi-function device of claim 15, wherein the controller is further operable to remove the destination from the address field if the destination is not included in the list of allowed destinations.

19. The multi-function device as set forth in claim 18, wherein the controller is further operable to generate an error report when a destination is removed from the address field.

20. The multi-function device as set forth in claim 15, further comprising a printer and a scanner.
